(19) United States
(12) Patent Application Publication
(10) Pub. No.: US 2026/0371154 A1
(43) Pub. Date: Nov. 19, 2026

(54) METHOD OF RADIO RESOURCE CONFIGURATION

(71) Applicant: ZTE Corporation, Shenzhen (CN)

(72) Inventors: Xiubin SHA, Shenzhen (CN); Yuan GAO, Shenzhen (CN); Yingjun ZHOU, Shenzhen (CN); He HUANG, Shenzhen (CN); Eswar Kalyan VUTUKURI, Shenzhen (CN)

(73) Assignee: ZTE Corporation, Shenzhen, GD (CN)

(21) Appl. No.: 19/461,113

(22) Filed: Jan. 27, 2026

Related U.S. Application Data
(63) Continuation of application No. PCT/CN2023/109768, filed on Jul. 28, 2023.

(51) Int. Cl. H04W 28/02; H04L 1/1812; H04L 43/0882; H04W 28/06; H04W 72/1268; H04W 72/51

(52) U.S. Cl. CPC H04W 28/0268; H04L 1/1812; H04L 43/0882; H04W 28/06; H04W 72/1268; H04W 72/51

(57) ABSTRACT

Methods, devices, and systems for providing awareness of a packet data unit (PDU) set dependency in a wireless communication system comprising a first wireless device and a second wireless device are disclosed. A plurality of PDU sets are transmitted from the first wireless device to the second wireless device. Each of the plurality of PDU sets comprises a plurality of PDUs each comprising a header and a payload. An indication is transmitted from the first wireless device to the second wireless device that describes a dependency relationship between one or more PDU sets of the plurality of PDU sets.

### CROSS-REFERENCE TO RELATED APPLICATIONS

The present application is a continuation of co-pending International Application No. PCT/CN2023/109768, filed Jul. 28, 2023. The contents of International Application No. PCT/CN2023/109768 are herein incorporated by reference in their entirety.

### TECHNICAL FIELD

The present subject matter is directed generally to wireless communications. Particularly, the present subject matter relates to methods, devices, and systems for awareness-based data transmission and reception for Metaverse and Multi-modality service, including Metaverse and Multi-modality service awareness in gNB, radio resource scheduling, and management for Metaverse and Multi-modality service delivery.

### BACKGROUND

Similar to the XR service, Metaverse and Multi-modality services may be considered video streaming services having high data rate and low latency requirements. The requirements may be expressed by multiple application frames (see H.264), such as I-frames, P-frames, and B-frames. The size of the application frame may be very large (e.g., tens of megabits) and restricted by the IP packet size (alternatively UDP or RTP). One application frame may be split into multiple IP (alternatively UDP or RTP) packet data units (PDUs) when delivering to the gNB. Each PDU comprises a header (e.g., a GTP-U header) and a payload. The multiple IP PDUs for one application frame may be expressed in PDU Set (e.g., a sequence of packets that includes all of the necessary information to reconstruct a video frame). A PDU set may be equivalent to a “media unit, “slice,” video/audio frame/tile, and/or haptic application information. In some cases, there may be dependency among PDU sets in a single QoS flow; e.g., one application data unit may include multiple application frames (see H.264), such as I-frames, P-frames, or B-frames. The decoding of the P-frame and/or B-frame may depend on the I-frame nearest and preceding the P-frame and/or B-frame. In one application data unit, the decoding of one application frame may depend on the application frame nearest and preceding the one application frame. One application frame may be more important than the subsequent application frame(s) depending on it. The PDU set in-sequence order may be identified by a PDU set sequence number; e.g., the PDU Set with a smaller PDU set sequence number is before the PDU set with a larger PDU set sequence number.

In some cases, there may be a synchronization relationship between PDU sets in multiple QoS flows of a single user equipment (UE); e.g., the video frame and voice frame may be in different QoS flows, but both frames should be transmitted simultaneously to the receiving side for synchronizing the video and audio.

In some cases, there may be a synchronization relationship between PDU sets in multiple QoS flows of different UEs; e.g., in XR games, a UE with VR glasses and a UE with gloves may be coordinated such that the communication to the application server should be synchronized for rendering.

In some cases, in order to provide an immersive user experience, the XR/media services with real-time interaction may typically require very low Round-Trip latency. Typically, during the roundtrip transmission (RTT) for XR/media traffic, the uplink (UL) and downlink (DL) latency requirements may be unbalanced and variable. Since the application function (AF) may lack dynamic information of the current UL/DL situation, it may be difficult for the AF to split the RTT requirement into UL and DL delay requirements in an optimized way. Supporting UL-DL transmission coordination to meet RTT latency requirements may be considered.

### SUMMARY

The present subject matter is directed to a method, device, and system for awareness of the PDU set dependency in one QoS flow. The PDU may set a coordination relationship between different QoS flows of a single UE, different UEs, and/or between mutually dependent UL QoS flows. Based on the awareness, a method may be provided for radio resource scheduling and management in a radio network.

In some embodiments a method for providing awareness of a packet data unit (PDU) set dependency in a wireless communication system comprising a first wireless device and a second wireless device, includes: transmitting a plurality of PDU sets from the first wireless device to the second wireless device, wherein each of the plurality of PDU sets comprises a plurality of PDUs each comprising a header and a payload; and transmitting an indication from the first wireless device to the second wireless device that describes a dependency relationship between one or more PDU sets of the plurality of PDU sets.

In some embodiments, a method of determining a Hybrid ARQ (Automatic Repeat reQuest) (HARQ) process ID for each configured grant (CG) occasion of a CG periodicity includes determining, by a user equipment (UE), the HARQ process ID for configured uplink (UL) grants neither configured with harq-ProcID-Offset2 nor cg-RetransmissionTimer according to the following equation: HARQ Process ID=[nrofCG-Occasions×floor(CURRENT_symbol/periodicity)+M] modulo nrofHARQ-Processes; and determining, by the UE, the HARQ process ID for a first symbol of a UL transmission according to the following equation: HARQ Process ID=[nrofCG-Occasions×floor(CURRENT_symbol/periodicity)+M] modulo nrofHARQ-Processes+harq-ProcID-Offset2, wherein nrofCG-Occasions is a number of CG occasions in one CG periodicity, M is a sequence number of the CG occasion in the CG periodicity, CURRENT_symbol=(system frame number (SFN)×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot.

In some embodiments, a method for a user equipment (UE) to avoid a UE capability filtering procedure during capability reporting in a wireless communication system comprising the UE and a base station, includes receiving, by the UE, a UECapabilityEnquiry from the base station, wherein the UECapabilityEnquiry comprises a full UE capability report request indication with or without a UE-capability request filter information; determining, by the UE, not to perform the UE capability filtering procedure; and sending a UECapabilityInformation comprising a full UE capability and/or a full UE capability reported indication to the base station.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example wireless communication system including a wireless base station/gNB 200 and user equipment (UE) 300.

FIG. 2 shows an example of a base station/gNB 200.

FIG. 3 shows an example of a UE 300.

FIG. 4A shows a swim lane diagram of an PDU set dependency indication and/or PDU set group information sent from a core network (CN) 250 to a gNB 200.

FIG. 4B shows a PDU Set Group Identification in a user plane (GTP-U header).

FIG. 4C shows a PDU Set Dependency Indication in a user plane (GTP-U header).

FIG. 5A shows communicating a Relationship Indication between PDU sessions and/or between QoS flows sent via a Control Plane from the core network (CN) 250 to a gNB 200.

FIG. 5B shows communicating a Relationship Indication between data radio bearers (DRBs) and/or between Logical CHannel groups (LCHs) sent via the control plane from a gNB 200 to a UE 300.

FIG. 5C shows a PDU Set Relationship Indication between QoS flows transmitted by a user plane (e.g., in the GTP-U header).

FIG. 5D shows a PDU Set Relationship Indication between QoS flows sent via the user plane (e.g., in the GTP-U header).

FIG. 6A shows communicating a Relationship Indication between PDU sessions and/or QoS flows of different UEs 300 transmitted via the control plane from a CN 250 to a gNB 200.

FIG. 6B shows a Relationship Indication communicated between DRBs and/or between LCHs of different UEs transmitted by the control plane.

FIG. 6C shows a PDU Set Relationship Indication between QoS flows of different UEs 300 transmitted via the user plane (e.g., in the GTP-U header).

FIG. 6D shows a PDU Set Relationship Indication between QoS flows transmitted via the user plane (e.g., in a GTP-U header).

FIG. 7A shows a PDU (set) RTT delay budget sent via the control plane (e.g., in a QoS flow Item) from a CN 250 to a gNB 200.

FIG. 7B shows an Associated UL PDU (set) size or Associated UL PDU (set) existence indication transmitted via the user plane (e.g., in a GTP-U header).

FIG. 8 shows a cell congestion indication for a UL PDU set discard.

FIG. 9A shows a PDU set integrity ratio or PDU error rate in one PDU set transmitted via the control plane from a CN 250 to a gNB 200.

FIG. 9B shows a PDU set integrity ratio or PDU error rate in one PDU set sent via the control plane from a gNB 200 to a UE 300.

FIG. 9C shows a PDU set information transfer during a handover procedure between a first and second node.

FIG. 10A shows a PDU Set Importance List or range information sent via control plane signaling from a CN 250 to a gNB 200.

FIG. 10B shows a mapping between PDU Set Importance 1030 to different DRB(s) and/or different LCH(s) 1035.

FIG. 11 shows configuration of PDCP Duplication for a PDU set with a certain PDU Set Importance when transmitted between a gNB 200 and a UE 300.

FIG. 12 shows a PDU Set Survival Time sent via the control plane from a CN 250 to a gNB 200.

FIG. 13 shows an example application data unit structure.

FIG. 14A shows a swim lane diagram of an example communication between a gNB 200 and a CN 250.

FIG. 14B shows a swim lane diagram of an example communication between a 5 200 and a UE 300.

FIG. 14C shows a swim lane diagram of an example communication between a 5G system (5GS) 1501 and an application layer 1502.

FIG. 15 shows an example where one CG period includes multiple CG occasions.

FIG. 16 shows an example for UE to avoid a UE capability filtering procedure during UE capability reporting.

### DETAILED DESCRIPTION

The present subject matter will now be described in detail hereinafter with reference to the accompanied drawings, which form a part of the present subject matter, and which show, by way of illustration, specific examples of embodiments. Please note that the present subject matter may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures, or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

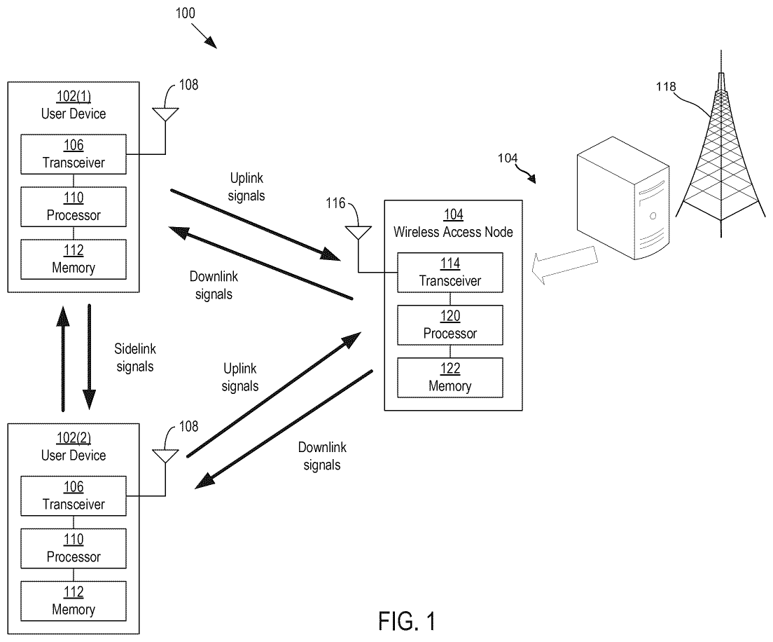

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless communication system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition, or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless communication system 100, the communication nodes are configured to wirelessly communicate signals between each other. In general, a communication in the wireless communication system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless communication system 100 can both send and receive signals, a single communication node may be both a transmitting/source node and a receiving/destination node simultaneously or switch between being a source/transmitting node and a destination/receiving node.

Also, particular signals may be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the wireless communication system 100 may be characterized or defined as a data signal or a control signal. In general, a data signal is a signal that includes or carries data, such multimedia data (e.g., voice and/or image data), and a control signal is a signal that carries control information that configures the communication nodes in certain ways to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

Additionally, in the wireless communication system 100, a slot format for a plurality of slots or frames may be configured by the wireless access node 104 or specified by a protocol. In some examples, a slot may be indicated or specified as a downlink slot, a flexible slot, or an uplink slot. Also, an orthogonal frequency divisional multiplexing (OFDM) symbol may be indicated or specified as a downlink symbol, a flexible symbol, or an uplink symbol, in various embodiments.

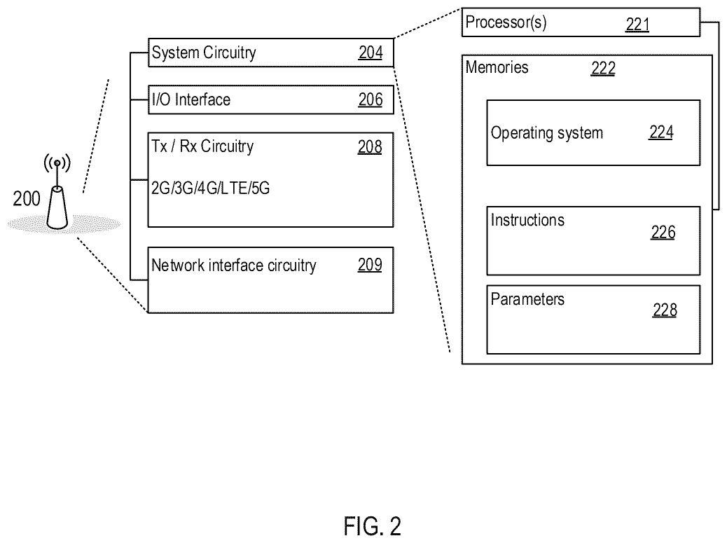

FIG. 2 shows an example of base station 200. The example base station 200 may include radio transmitting/receiving (Tx/Rx) circuitry 208 to transmit/receive communication with UEs and/or other base stations. The base station 200 may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

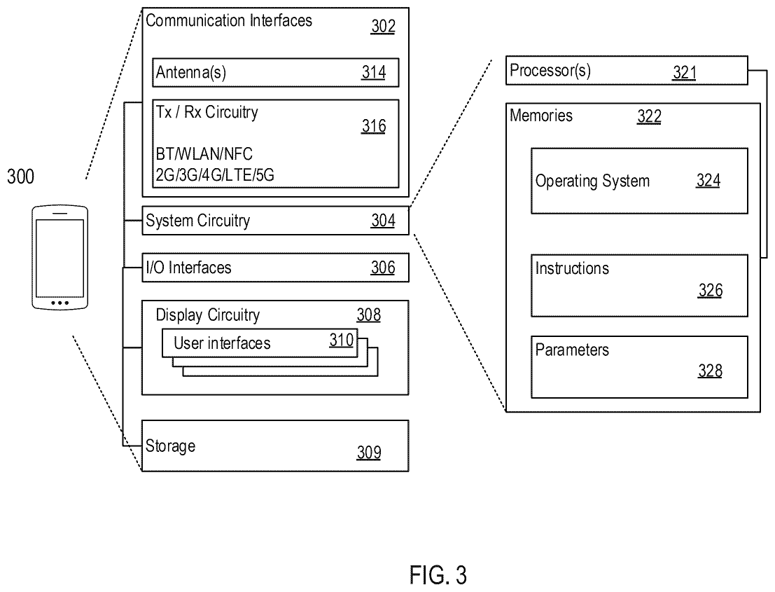

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers, and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

The system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

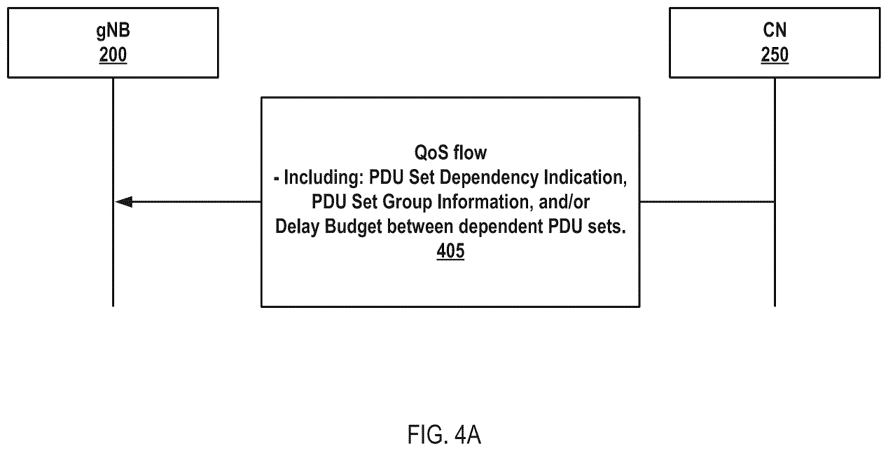

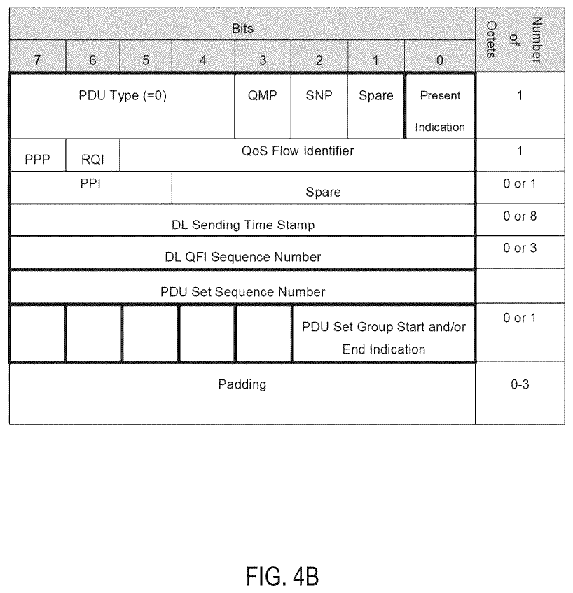

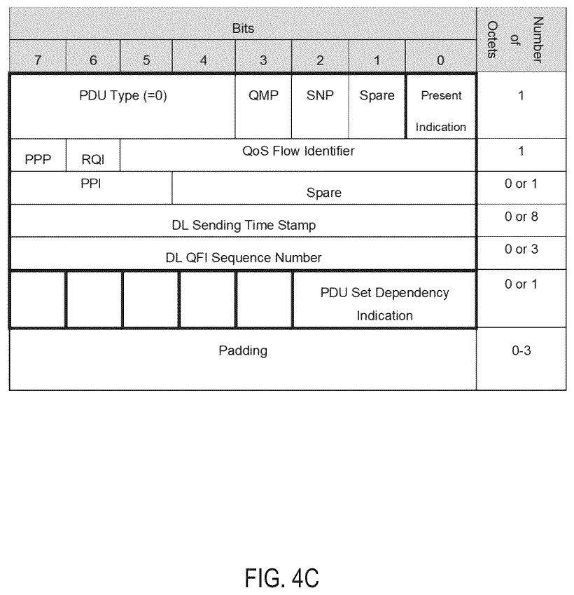

FIG. 4A shows a swim lane diagram of an PDU set dependency indication, PDU set group information and/or delay budget between dependent PDU sets sent from a core network (CN) 250 to a gNB 200, also known as a base station, in accordance with the present subject matter. The PDU Set Dependency Indication, the PDU Set Group Information and/or delay budget between dependent PDU sets may be set per QoS flow 405 (e.g., included in the QoS flow item). The PDU Set Dependency Indication may indicate whether a dependency between PDU sets should be considered for the PDU set delivery. If the PDU Set Dependency is included in the QoS flow 405, the PDU set dependency should be considered for delivery; i.e., in-sequence delivery should be performed. If the former PDU set is lost, the following PDU set(s) that depend on the former PDU set should not be delivered and instead discarded. A PDU set group includes a group of PDU sets that depend on one other for decoding. A PDU set includes a group of PDUs

The PDU Set Group Information may include at least one of the following: whether PDU set group information should be considered for PDU set delivery, the delay budget of PDU set group (e.g., the upper bound for the delay that a PDU Set Group may experience for the transfer between the UE 300 and the N6 termination point at the User Plane Function (UPF)), the error rate of the PDU set group (e.g., the upper bound for the error rate of the PDU set groups that have been processed by the sender of a radio link layer protocol), the survival time of the PDU set group (e.g., the time deadline by which the PDU set group should be delivered to the receiving side, or alternatively, the time period that the PDU set group can survive being delivered to the receiving side; otherwise the PDU set group is discarded).

The delay budget between dependent PDU sets may indicate an upper bound for the time that a dependent PDU set may be delayed when a PDU set arrives, or an upper bound for the time that two dependent PDU sets or more than two PDU sets should arrives in. If at least one of the dependent PDU sets among the dependent PDU sets has not arrived during the delay budget, the other PDU set in the dependent PDU set may be useless and should not be transmitted and may be discarded.

The same PDU Set Dependency Indication, PDU Set Group Information, and/or delay budget between dependent PDU sets may also be transmitted by Control Plane signaling from the gNB-CU to the gNB-DU, or from a source gNB to a target gNB.

FIG. 4B shows a PDU Set Group Identification in a user plane (GTP-U header). The PDU Set Group Start and/or End Indication is included in the GTP-U header. If the PDU Set Group Start Indication is included in the user plane (e.g., the GTP-U header) of the PDU set, it may indicate that the PDU set is the first PDU set of the PDU Set Group. If the PDU Set Group end indication is included in the user plane (e.g., the GTP-U header) of the PDU set, it may indicate that the PDU set is the last PDU set of the PDU Set Group. If the PDU Set Group Start Indication and PDU Set Group End Indication are included in the user plane (e.g., the GTP-U header) of the PDU set, it may mean that the PDU Set Group has only one PDU set. Alternatively, or in addition, a predefined value of the PDU Set Group Start and/or End Indication field in the user plane (e.g., GTP-U header) of the PDU set may be used to indicate that the PDU Set Group has only one PDU set.

For backward compatibility with a system management function (SMF) that may or may not support the new information provided in the GTP-U header, a spare bit (e.g., used as the Present Indication (of PDU Set Group Start and/or End Indication) field) in the GTP-U header may be used to indicate whether the PDU Set Group Start, End Indication field and/or delay budget between dependent PDU sets is present. A value of “0” may indicate “not present,” while a value of “1” may indicate “present.” In another example, spare bits in the GTP-U header may be used for the PDU Set Group Start and/or End Indication where a value of “0” may indicate the PDU Set Group Start and/or End Indication field is not present.

In some examples, if the PDU Set Group Start and/or End Indication field are included in the user plane (e.g., GTP-U header) of the PDU set, it may implicitly indicate that dependencies exist among the PDU sets in the PDU set group; e.g., one PDU set depends on a PDU set nearest and preceding the one PDU set. If one PDU set is lost, the PDU set that depends on the lost PDU set should not be transmitted. The PDU set group may also be an application data unit.

Similar PDU set group information may also be included in an Service Data Adaption Protocol (SDAP) header, PDCP PDU header, and/or a radio link protocol (RLC) PDU header, which is used for PDU set group identification, resource scheduling, and/or a PDU set discarding decision.

FIG. 4C shows a PDU Set Dependency Indication in a user plane (GTP-U header). The PDU Set Dependency Indication may be included in the GTP-U header. The PDU Set Dependency Indication may indicate at least one of: that the PDU set does not depend on any other PDU set; that the one PDU set depends on the PDU set of the current QoS flow nearest and preceding the one PDU set; that the one PDU set not only depends on the PDU set of the current QoS flow nearest and preceding the one PDU set but also depends on the PDU set of the current QoS flow nearest and following the one PDU set.

For backward compatibility with an SMF that may or may not support the new information provided in the GTP-U header, a spare bit (e.g., used as the Present Indication (of PDU Set Dependency Indication) field) in the GTP-U header may be used to indicate whether the PDU Set Dependency Indication field is present. A value of “0” may indicate “not present,” while a value of “1” may indicate “present.” In another example, spare bits in the GTP-U header may be used for the PDU Set Dependency Indication where a value of “0” may indicate the PDU Set Dependency Indication is not present.

In some examples, if the PDU Set Dependency Indication field are included in the user plane (e.g., GTP-U header) of the PDU set, it may indicate that dependencies existing among the PDU sets should be considered; e.g., one PDU set depends on a PDU set nearest and preceding the one PDU set. If one PDU set is lost, the PDU set that depends on the lost PDU set should not be transmitted.

The similar PDU set dependency information may also be included in an SDAP header, PDCP PDU header, and/or an RLC PDU header, which is used for PDU set dependency identification, resource scheduling, and/or a PDU set discarding decision.

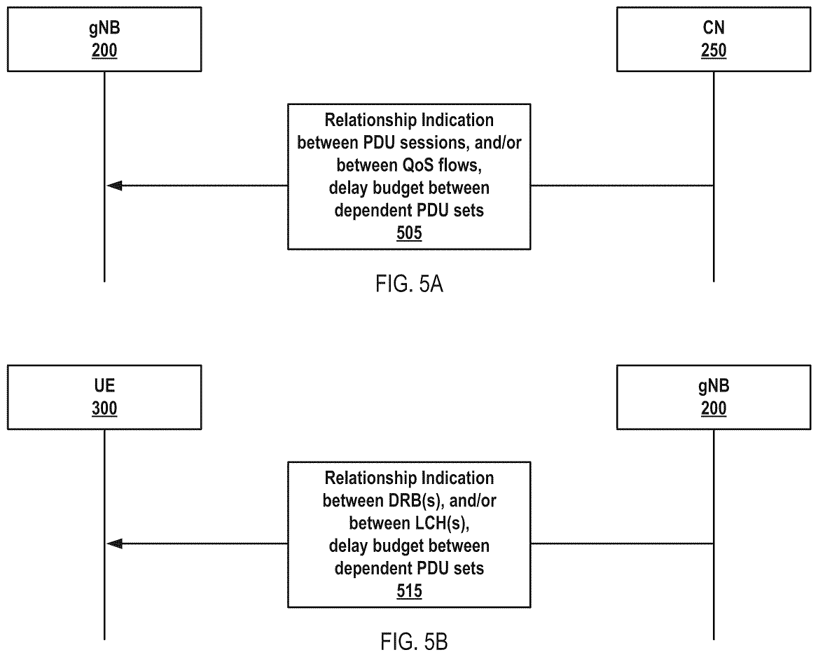

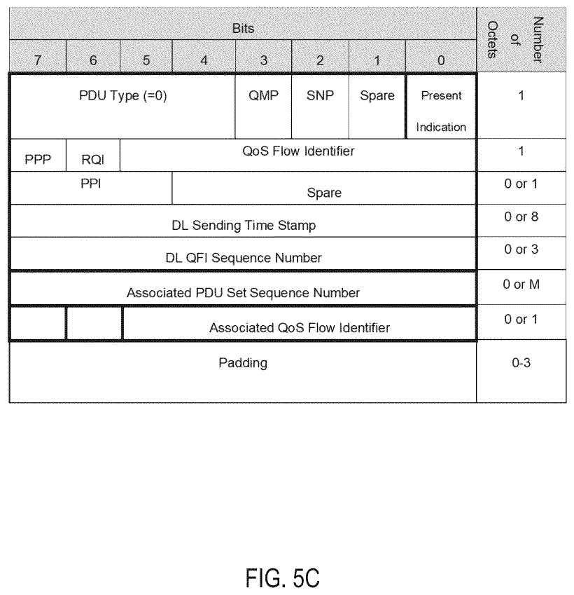

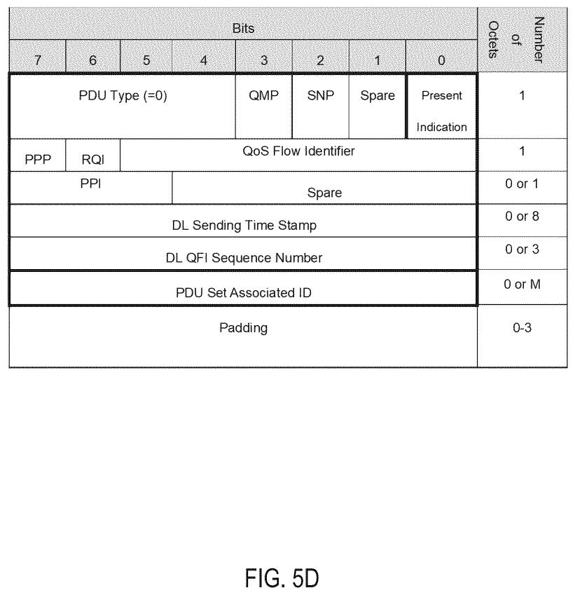

FIG. 5A shows communicating a Relationship Indication 505 between PDU sessions and/or between QoS flows sent via a Control Plane from the core network (CN) 250 to a gNB 200. The Relationship Indication 505 between PDU sessions and/or between QoS flows may be transmitted via the Control Plane from the CN 250 to the gNB 200. The Relationship Indication 505 between PDU sessions and/or QoS flows may be indicated by at least one of: a global Relationship Identifier (e.g., a PDU Set Group Identity or a PDU set associated ID) associated with multiple PDU sessions or multiple QoS flows (e.g., the multiple PDU sessions or multiple QoS flows having the same global Relationship Identifier have relationships). For instance, the PDU set in one PDU session or QoS flow may depend on the PDU set in another PDU session or QoS flow. The Relationship Indication 505 may be further indicated by an associated second PDU session ID in a first PDU session, and/or an associated second QoS flow ID in a first QoS flow item.

If included, the PDU set sequence number may be coded across the associated PDU sessions or associated QoS flows; e.g., a PDU set in-sequence delivery of different PDU sessions or QoS flows should be performed, and if the preceding PDU set is lost, the following PDU Set(s) depending on the preceding PDU set should not be delivered and instead discarded. In which case, delay budget between dependent PDU sets may also be included with the Relationship Indication between PDU sessions and/or between QoS flows.

The delay budget between dependent PDU sets indicates an upper bound for the time that a dependent PDU set may be delayed when a PDU set arrives, or an upper bound for the time that two dependent PDU sets or more than two PDU sets should arrives in. If at least one of the dependent PDU set among the dependent PDU sets has not arrived during the delay budget, the other PDU set in the dependent PDU sets may be useless and should not be transmitted and may be discarded.

A similar Relationship Indication 505 between PDU sessions, between QoS flows by the Control Plane and/or delay budget between dependent PDU sets may also be transmitted using Control Plane signaling from the gNB-CU to the gNB-DU, or from a source gNB to a target gNB.

FIG. 5B shows communicating a Relationship Indication 515 between data radio bearers (DRBs) and/or between Logical CHannel groups (LCHs) sent via the control plane from a gNB 200 to a UE 300. The Relationship Indication 515 between DRBs and/or between LCHs may be indicated by at least one of: a global Relationship identifier (e.g., a Group identity) associated with multiple DRBs or multiple LCHs (e.g., the multiple DRBs or multiple LCHs having a same global Relationship identifier have relationships; e.g., the PDU set in one DRB or LCH may depend on the PDU set in another DRB or LCH), an associated second DRB ID in a first DRB configuration, and/or an associated second LCH ID in a first LCH configuration.

If included, the PDU set sequence number may be coded across the associated DRBs or associated LCHs; e.g., a PDU set in-sequence delivery of different DRBs or LCHs should be performed. If the former PDU set is lost, the subsequent PDU set(s) that depend on the former PDU set should not be delivered and instead discarded. In which case, delay budget between dependent PDU sets may also be included associated with the Relationship Indication between PDU sessions and/or between QoS flows.

The delay budget between dependent PDU sets indicates an upper bound for the time that a dependent PDU set may be delayed when a PDU set arrives, or an upper bound for the time that two dependent PDU sets or more than two PDU sets should arrives in. If at least one of the dependent PDU set among the dependent PDU sets has not arrived during the delay budget, the other PDU set in the dependent PDU sets may be useless and should not be transmitted anymore, and may be discarded.

FIG. 5C shows a PDU Set Relationship Indication between QoS flows transmitted by a user plane (e.g., in the GTP-U header). The Associated PDU Set Sequence Number and/or Associated QoS Flow Identifier may be included in the user plane (e.g., in the GTP-U header). These fields may indicate that the current PDU set associates with a PDU set indicated by the Associated PDU Set Sequence Number and/or the Associated QoS Flow Identifier; e.g., the current PDU set and the associated PDU set should be transmitted jointly or simultaneously, and/or that the current PDU set depends on the associated PDU set; e.g., if the associated PDU set is lost, the current PDU set should not be transmitted.

For backward compatibility with an SMF that may or may not support the new information provided in the GTP-U header, a spare bit (e.g., the Present Indication of Associated PDU Set Sequence Number and/or the Associated QoS Flow Identifier field) in the GTP-U header may be used to indicate whether the Associated PDU Set Sequence Number and/or Associated QoS Flow Identifier field is present. A value of “0” may indicate “not present,” while a value of “1” may indicate “present.”

If the PDU Set Sequence Number is coded across multiple PDU sessions or multiple QoS flows, the PDU Set Group Start and/or End Indication (as shown in FIG. 4B) may also be used for PDU Set Relationship Indication between PDU sessions or between QoS flows.

The Associated PDU Session Identifier may also be included in the GTP-U header to indicate that the PDU sets in different PDU sessions are associated (e.g., the Associated PDU Set Sequence Number and/or Associated QoS Flow Identifier as shown in FIG. 4D may be replaced by an Associated PDU Set Sequence Number, Associated QoS Flow Identifier, and/or an Associated PDU Session Identifier).

The corresponding PDU Set Relationship Indication may also be included in a PDCP header (e.g., including the Associated PDU Set Sequence Number and/or Associated DRB Identifier) and/or the RLC header (e.g., including the Associated PDU Set Sequence Number and/or Associated LCH Identifier) for lower layer to identify the PDU set relationship, resource scheduling, and/or PDU set discarding decision.

FIG. 5D shows a PDU Set Relationship Indication between QoS flows sent via the user plane (e.g., in the GTP-U header). The PDU Set Associated ID may be included in the user plane (e.g., in the GTP-U header). This field may indicate that the PDU sets having the same PDU Set Associated ID have relationships; e.g., the associated PDU sets should be transmitted jointly or simultaneously.

For backward compatibility with an SMF that may or may not support the new information provided in the GTP-U header, a spare bit (e.g., used as the Present Indication of PDU Set Associated ID field) in the GTP-U header may be used to indicate whether the PDU Set Associated ID field is present. A value of “0” may indicate “not present,” while a value of “1” may indicate “present.”

The corresponding PDU Set Associated ID may also be included in a PDCP header and/or an RLC (e.g., including the Associated PDU Set Sequence Number and/or Associated LCH Identifier) for lower layer to identify the PDU set relationship, resource scheduling, and/or PDU set discarding decision.

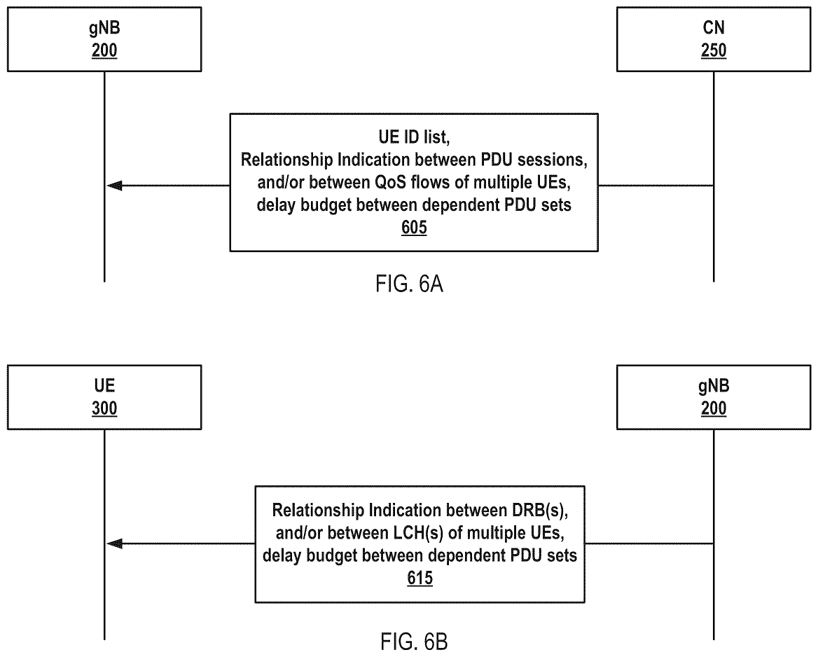

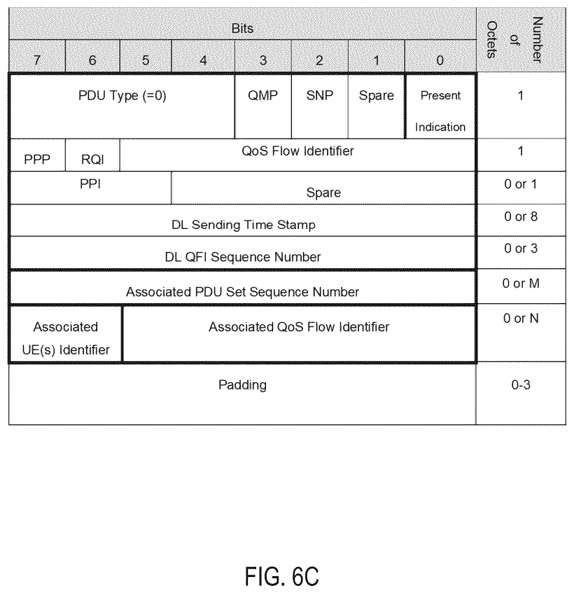

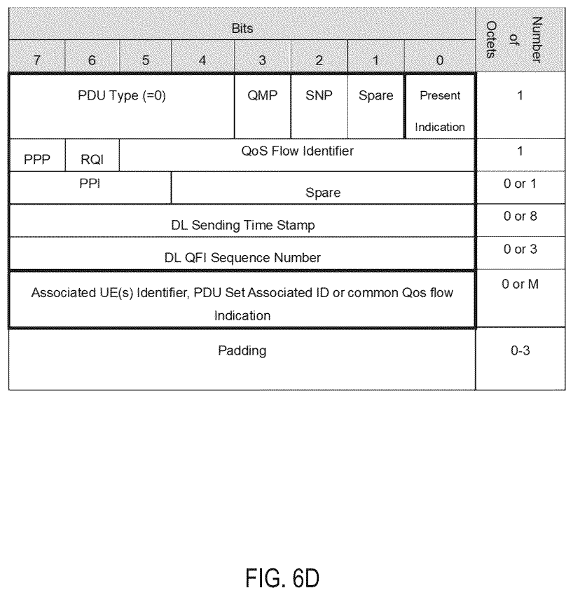

FIG. 6A shows communicating a Relationship Indication 605 between PDU sessions and/or QoS flows of different UEs 300 transmitted via the control plane from a CN 250 to a gNB 200. At least one of the following information is transmitted via the control plane from the CN 250 to the gNB 200: a UE ID list, a Relationship Indication 605 between PDU sessions and/or between QoS flows of different UEs 300. The Relationship Indication 605 between PDU sessions and/or between QoS flows of different UEs 300 may be indicated by at least one of: a global Relationship identifier (e.g., a PDU set group identity or a PDU set associated ID) associated with multiple UEs 300 (e.g., the PDU sets with the same global Relationship Identifier have relationships; the PDU set in one PDU session or QoS flow may depend on the PDU set in another PDU session or QoS flow), an associated second PDU session ID in a first PDU session, an associated second QoS flow ID in a first QoS flow item, and/or an associated second UE ID in a first UE signaling, Common PDU sessions and/or Common QoS flows for multiple UEs, and/or a UE ID list may be used to indicate the multiple UEs that have a relationship between PDU sessions and/or between QoS flows. In which case, delay budget between dependent PDU sets may also be included associated with the Relationship Indication between PDU sessions and/or between QoS flows.

The delay budget between dependent PDU sets indicates an upper bound for the time that a dependent PDU set may be delayed when a PDU set arrives, or an upper bound for the time that two dependent PDU sets or more than two PDU sets should arrives in. If at least one of the dependent PDU set among the dependent PDU sets has not arrived during the delay budget, the other PDU set in the dependent PDU sets may be useless and should not be transmitted anymore, and may be discarded.

The similar Relationship Indication 605 between PDU sessions and/or between QoS flows via the control plane of different UEs and/or delay budget between dependent PDU sets may also be transmitted by control plane signaling from the gNB-CU to the gNB-DU or from a source gNB 200 to a target gNB 200.

FIG. 6B shows a Relationship Indication 615 communicated between DRBs and/or between LCHs of different UEs transmitted by the control plane. The QoS flows that have a PDU set relationship among multiple UEs 300 (e.g., within one UE group) may be mapped to two sets of radio configurations (e.g., mapped to common DRBs, common LCHs, common USS and dedicated DRBs, dedicated LCHs, and/or dedicated USS) so that the common PDU set may be sent to multiple UEs 300 having a common resource for NW power saving and capacity improvement. In this case, each UE 300 may have its own HARQ process and/or RLC ARQ process and may trigger retransmission on a dedicated configuration. In which case, delay budget between dependent PDU sets may also be included associated with the Relationship Indication between PDU sessions and/or between QoS flows.

The delay budget between dependent PDU sets indicates an upper bound for the time that a dependent PDU set may be delayed when a PDU set arrives, or an upper bound for the time that two dependent PDU sets or more than two PDU sets should arrives in. If at least one of the dependent PDU set among the dependent PDU sets has not arrived during the delay budget, the other PDU set in the dependent PDU sets may be useless and should not be transmitted anymore and may be discarded.

FIG. 6C shows a PDU Set Relationship Indication between QoS flows of different UEs 300 transmitted via the user plane (e.g., in the GTP-U header). The associated PDU Set Sequence Number, Associated QoS Flow Identifier, and/or the Associated UE Identifier may be included in the user plane (e.g., in the GTP-U header). These fields may indicate that the current PDU set associates with a PDU set indicated by the Associated PDU Set Sequence Number, the Associated QoS Flow Identifier, and/or the Associated UE Identifier; e.g., the current PDU set and the associated PDU set should be transmitted jointly or simultaneously, and/or that the current PDU set depends on the associated PDU set; e.g., if the associated PDU set is lost, the current PDU set should not be transmitted.

For backward compatibility with an SMF that may or may not support the new information provided in the GTP-U header, a spare bit (e.g., used as the Present Indication of the Associated PDU Set Sequence Number, Associated QoS Flow Identifier, and/or the Associated UE Identifier field) in the GTP-U header may be used to indicate whether the Associated PDU Set Sequence Number and/or Associated QoS Flow Identifier field is present. A value of “0” may indicate “not present,” while a value of “1” may indicate “present.”

An Associated PDU Session Identifier may also be included in the GTP-U header to indicate that the PDU sets in different PDU sessions are associated (e.g., the Associated PDU Set Sequence Number, Associated QoS Flow Identifier, and/or Associated UE Identifier in FIG. 4F may be replaced by an Associated PDU Set Sequence Number, Associated QoS Flow Identifier, Associated PDU Session Identifier, and/or Associated UE Identifier.

The corresponding PDU Set Relationship Indication 615 may also be indicated in a PDCP header (e.g., including an Associated PDU Set Sequence Number, Associated DRB Identifier, and/or Associated UE Identifier) and/or RLC header (e.g., including an Associated PDU Set Sequence Number, Associated LCH Identifier, and/or Associated UE Identifier) for lower layer to identify the PDU set relationship, resource scheduling, and/or PDU set discarding decision.

FIG. 6D shows a PDU Set Relationship Indication between QoS flows transmitted via the user plane (e.g., in a GTP-U header). The Associated UE(s) Identifier, PDU Set Associated ID, or common QoS flow Indication may be included in the user plane (e.g., in the GTP-U header). Including the PDU Set Associated ID is in the user plane may indicate that the PDU sets with the same PDU Set Associated ID have relationships; e.g., the associated PDU sets should be transmitted jointly or simultaneously.

Including the Associated UE(s) Identifier or common QoS flow Indication in the user plane may indicate that the PDU sets should be transmitted to multiple UEs 300.

For backward compatibility with an SMF that may or may not support the new information provided in the GTP-U header, a spare bit (e.g., used as the Present Indication of PDU Set Associated ID field) in the GTP-U header may be used to indicate whether the PDU Set Associated ID field is present. A value of “0” may indicate “not present,” while a value of “1” may indicate “present.”

If the Associated UE(s) Identifier, PDU Set Associated ID, or common QoS flow Indication is included in the user plane (e.g., in the GTP-U header) of the PDU set, the PDU set may be sent to multiple UEs 300 via dedicated scheduling, or initial transmission may be sent to multiple UEs 300 by common scheduling (e.g., by common radio configurations as shown in FIG. 6B) and retransmission may be sent to multiple UEs 300 via dedicated scheduling (e.g., by dedicated radio configurations) based on dedicated HARQ process and/or dedicated RLC process.

The corresponding PDU Set Associated ID may also be included in a PDCP header and/or an RLC (e.g., including Associated PDU Set Sequence Number and/or Associated LCH Identifier) for lower layer to identify the PDU set relationship, resource scheduling, and/or PDU set discarding decision.

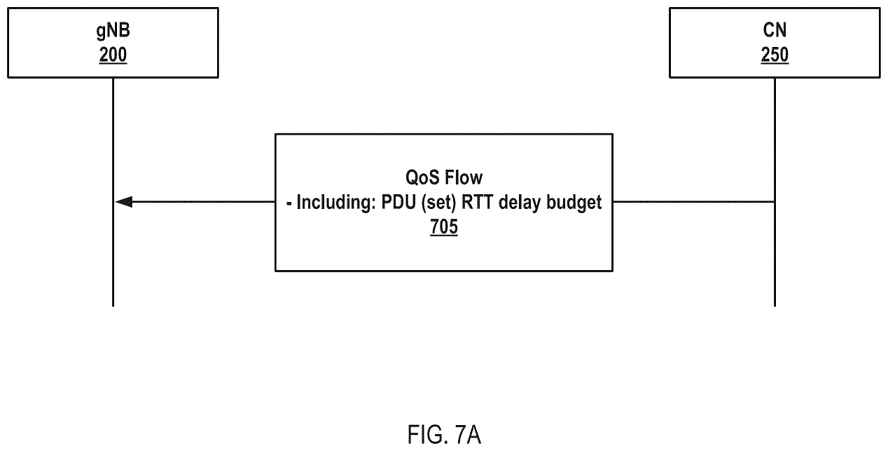

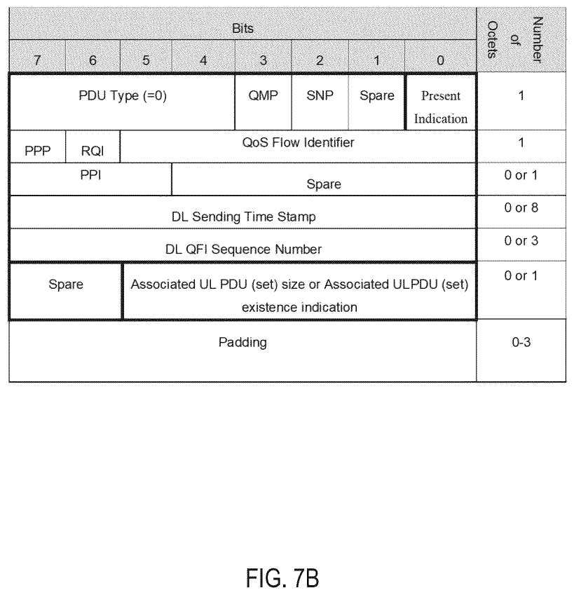

FIG. 7A shows a PDU (set) RTT delay budget 705 sent via the control plane (e.g., in a QoS flow Item) from a CN 250 to a gNB 200, which may indicate the upper bound for the delay from the time that a PDU (set) is sent to the time that a response PDU (set) is received; e.g., the upper bound for the RTT delay from the UE 300 to the N6 termination point at the UPF and then to the UE 300, or the upper bound for the RTT delay from the N6 termination point at the UPF to the UE 300, and then to the N6 termination point at the UPF.

Including the PDU (set) RTT delay budget 705 in the QoS flow may implicitly indicate that a DL PDU (set) has an associated UL PDU (set); e.g., a UL PDU (set) may respond to each DL PDU (set).

The same PDU (set) RTT delay budget 705 may be transmitted via the control plane (e.g., in a QoS flow Item) from a gNB-CU to a gNB-DU or from a source gNB 200 to a target gNB 200.

FIG. 7B shows an Associated UL PDU (set) size or Associated UL PDU (set) existence indication transmitted via the user plane (e.g., in a GTP-U header). The Associated UL PDU (set) size or Associated UL PDU (set) existence indication may be included in the user plane (e.g., in the GTP-U header). This field may indicate that the DL PDU (set) has an associated UL PDU (set) and/or the size of the associated UL PDU (set).

For backward compatibility with an SMF that may or may not support the new information provided in the GTP-U header, a spare bit (e.g., used as the Present Indication of Associated UL PDU (set) size or Associated UL PDU (set) existence indication field) in the GTP-U header may be used to indicate whether the Associated UL PDU (set) size or Associated UL PDU (set) existence indication field is present. A value of “0” may indicate “not present,” while a value of “1” may indicate “present.” In another example, spare bits in the GTP-U header may be used for the Associated UL PDU (set) size or Associated UL PDU (set) existence indication, and a value of “0” may indicate the Associated UL PDU (set) size or Associated UL PDU (set) existence indication field is not present.

If the Associated UL PDU (set) size or Associated UL PDU (set) existence indication is included in the user plane (e.g., in the GTP-U header), the following mechanism(s) may be used. In a first solution, the DCI for scheduling of the PDSCH may also include the UL grant for scheduling of the PUSCH (e.g., the same DCI may include both scheduling of the PDSCH and the scheduling of the PUSCH), in which, the slot and/or subframe of the UL grant may also be indicated implicitly (e.g., by pre-defined rules) or explicitly (e.g., by absolute symbol and/or slot field, or by time offset from when the DCI is received (e.g., the UL grant may is used with an offset of number of symbols and/or number of slots after the DCI is received).

In a second solution, the DCI for scheduling of the PDSCH may correlate a PUCCH and/or a UCI that can include buffer status report (BSR) information.

In a third solution, the DCI for scheduling of the PDSCH may configure and/or activate a BSR resource with a pre-defined time offset; e.g., after the UE 300 receives the PDSCH, a PUSCH resource for BSR may be configured and/or activated to report the size of the response UL PDU (set). The PUSCH resource for the BSR may be preconfigured by RRC and activated when receiving the PDSCH or configured and activated by the DCI. The time offset between PDSCH reception and the PUSCH transmission for the BSR may be predefined or configured via DCI or RRC.

In a fourth solution, the Associated UL PDU set existence indication or SR/BSR prohibit indication may be included in the DCI for scheduling of the PDSCH, or in any of the PDCP header, the RLC header, or the MAC header, which may indicate that a UL grant may be scheduled immediately, based on a gNB 200 implementation. Upon receiving the Associated UL PDU set existence indication or SR/BSR prohibit indication, the SR and/or BSR may be prohibited for a duration; e.g., an SR prohibit timer or BSR prohibit timer may be started or restarted in the UE 300. When the SR prohibit timer or BSR prohibit timer is running, SR and/or BSR may not be triggered. The time length of the SR prohibit timer and/or BSR prohibit timer may be predefined or configured via an RRC message, PDCP header, MAC header, or DCI.

So that the gNB 200 can decide the UL transmission delay, time information (i.e., the time of the initial transmission) or delay information (e.g., the packet cached duration in the PDCP) may be included in the PDCP header.

The time delay information may be an absolute time stamp or a 5GS resource synchronization timing (e.g., system frame number (SFN), slot, and/or symbol) when the packet(s) arrive at the UE PDCP or PDCP upper SAP. The delay information may be the time duration from the occasion that the packet(s) arrives at the UE PDCP or the PDCP upper SAP to the occasion of the packet initial transmission in the UE 300). When the delay information is included, the reference time (e.g., reference SFN, reference slot, and/or reference symbol) should also be included to decide the occasion of the initial transmission.

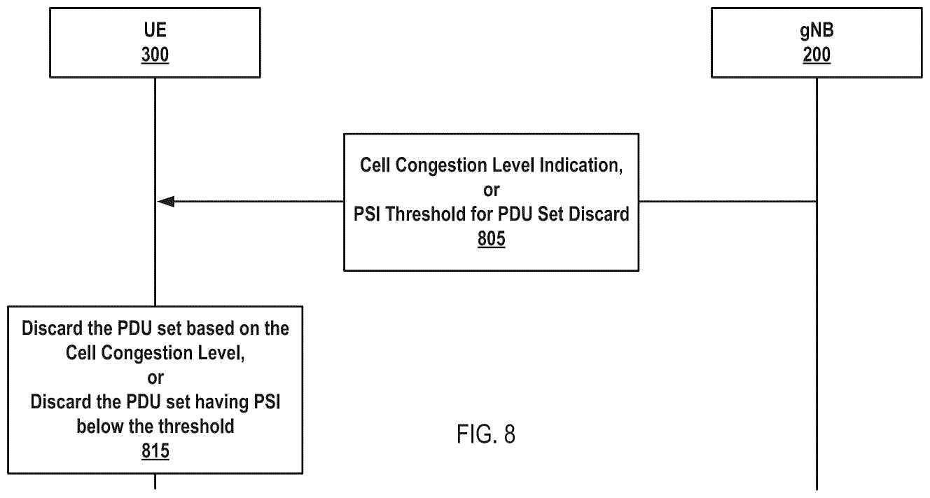

FIG. 8 shows a cell congestion indication 805 for a UL PDU set discard. Sixteen levels of PSI (PDU Set Importance) may be configured using 4 bits, for example, as follows: The PDU Set Importance field may indicate the importance of one PDU set compared to other PDU sets within the same RTP stream. Lower values may indicate a higher importance PDU set with the highest importance PDU set indicated by “0 ” and the lowest important PDU set indicated by 15.

The PDU set with the lower importance may be discarded when the cell is in a congestion state. The PDU set with a different PSI level may be discarded based on different cell congestion levels. In an example, the PDU set with the highest PSI level may be discarded. Based on a cell congestion level, a PSI threshold 805 for PDU set discarding may be configured in the UE 300. A PSI threshold 805 for PDU set discarding or PSI range for PDU set discarding may be sent to a UE 300 so the UE 300 can determine the PDU set with which PSI level should be discarded.

If the cell congestion level is sent to the UE 300, the UE 300 can determine to discard 815 the PDU set based on the cell congestion level; e.g., when the cell is in congestion level 15, which may be the lowest congestion level, the UE 300 may discard 815 the PDU set(s) having a PSI of 15, which may indicate that PDU set has the lowest importance). When the cell is in congestion level 14, the UE 300 may discard 815 the PDU set(s) having a PSI of 14 and/or 15. When the cell is in congestion level 13, the UE 300 may discard 815 the PDU set(s) having PSI of 13, 14, and/or 15, and so forth.

If the PSI threshold 805 for the PDU set discarding is sent to the UE 300, the UE 300 can determine to discard 815 the PDU set based on the PSI threshold 805 for PDU set discarding; the PDU set with a PSI equal to or lower than the PSI threshold 805 may be discarded 815. For instance, when the PSI threshold 805 is configured as 15 (the lowest congestion level), the UE 300 may discard 815 the PDU set(s) having a PSI of 15 (lowest PDU Set mportance). When the PSI threshold 805 is set to 14, the UE 300 may discard 815 the PDU set(s) having PSI 14 and/or 15. When the PSI threshold 805 is set to 13, the UE 300 may discard 815 the PDU set(s) having a PSI of 13, 14, and/or 15, and so forth.

If the PSI range for the PDU set discarding is sent to the UE 300, the UE 300 may determine to discard 815 the PDU set(s) based on the PSI range for PDU set discarding; the PDU set with the PSI in the PSI range may be discarded 815. The cell congestion level, PSI threshold 805 for PDU set discarding, or PSI range for PDU set discarding may be sent to the UE 300 via an RRC message, via a PDCP header, via a MAC CE, or via DCI. When sending via MAC CE or DCI, a common MAC CE or common DCI (e.g., scheduled by common PDCCH search space and scrambled with common Cell Radio Network Temporary Identifier (C-RNTI) may be used for less signaling.

In another example, different PDU set discardTimer(s) may be configured for different PSIs (e.g., a shorter PDU set discardTimer may be configured for a lower PSI, while a longer PDU set discardTimer may be configured for a higher PSI). Thus, in a congestion state, the PDU set having the lower PSI may be more easily discarded. The PDU set discardTimer per PSI or per PSI value range may be configured via RRC message and updated by either RRC message or MAC CE.

In another example: PSI is considered in LCP determination or PDU (set) selection for UL transmission. For example: PSI weight for LCP determination for each PSI is sent to UE, when selecting the Logical CHannel (LCH) for UL transmission, the priority of LCH * the PSI weight of PDU set with highest PSI in the LCH is used as the priority for LCH selection (e.g., selecting the LCH in a decreasing priority order). The PSI weight can be configured by gNB explicitly, or can be an implicitly value, e.g. 1/(PSI+1), or 1/PSI and the weight may be a predefined value or a infinity large value, PSI weight can also be PSI value, e.g. the PSI of PDU set with the highest PSI in the LCH is used as the LCH priority for LCH priority determination. When a LCH is selected, the PDU (set) with higher PSI may be selected with hhigher priority for transmission. With this method, the PDU (set) with higher PSI may be transmitted with higher priority, the PDU (set) with lower PSI may more easily discarded due to the discardTimer expiring.

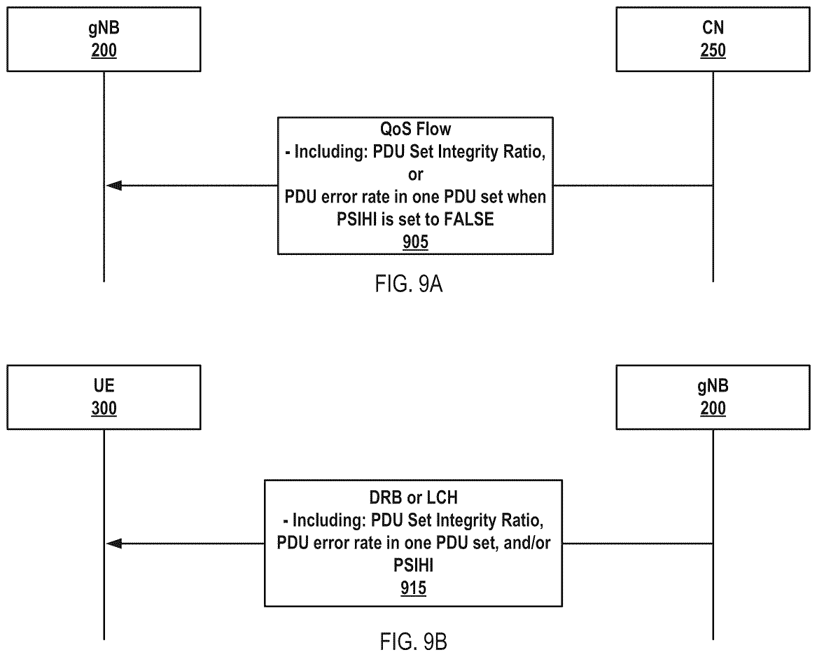

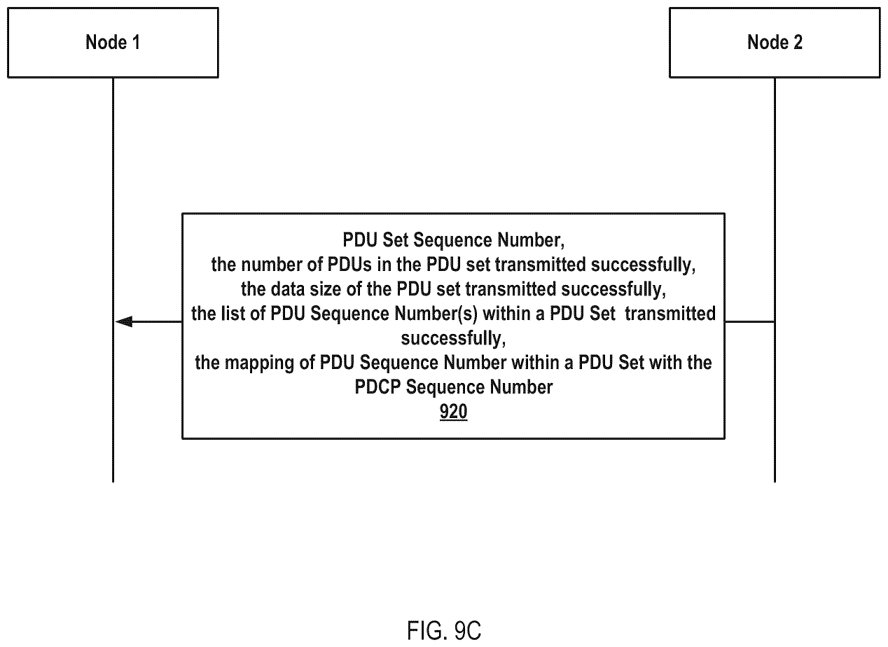

FIG. 9A shows transmitting a PDU set integrity ratio or PDU error rate 905 in one PDU set transmitted via the control plane from a CN 250 to a gNB 200. A PDU Set Integrated Handling Information (PSIHI) may be indicated from the CN 250 to the gNB 200 and may indicate whether all PDUs of the PDU set are needed for use of the PDU set by the application layer. When the PSIHI is set to TRUE, if one PDU is lost, the other PDU(s) of the PDU set may be useless to the receiving entity and should not be transmitted. When the PSIHI is set to FALSE, if some PDU(s) are lost, the other PDU(s) of the PDU set may also be used; e.g., the FEC algorithm may be used in the receiving entity for decoding the PDU set. In this case, the PDU set integrity ratio or PDU error rate 905 in one PDU set should be sent from the CN 250 to the UE 300 to indicate the minimal PDU success rate in one PDU set or the maximal PDU error rate 905 in one PDU set that is acceptable for using the PDU set by the application layer. If the PDU error rate in one PDU set exceeds the configured PDU error rate in one PDU set, the other PDU(s) of the PDU set may be useless to the receiving entity and should not be transmitted and discarded. If the PDUs in the PDU set do not meet or exceed the PDU set integrity ratio, the other PDU(s) of the PDU set may be useless to the receiving entity and should not be transmitted and discarded.

A similar PDU set integrity ratio or PDU error rate in one PDU set may also be sent via control plane signaling from a gNB-CU to a gNB-DU or from a source gNB 200 to a target gNB 200.

FIG. 9B shows a PDU set integrity ratio or PDU error rate 915 in one PDU set sent via the control plane from a gNB 200 to a UE 300. For the UE 300 to decide the UL PDU set integrity, the gNB 200 should send the PDU set integrity ratio, PDU error rate 915 in one PDU set, and/or PSIHI to the UE 300. The PDU set integrity ratio, PDU error rate 915 in one PDU set, and/or PSIHI may be configured per DRB or per LCH via RRC message and updated by RRC message or MAC CE.

FIG. 9C shows a PDU set information transfer 920 during a handover procedure between a first and second node (e.g., Node 1, Node 2). At least one of the following information may be transmitted from Node 1 to Node 2: PDU set Sequence Number, the number of PDUs in the PDU set that have been transmitted successfully, the data size of the PDU set that has been transmitted successfully, the list of PDU Sequence Number(s) within a PDU Set that have been transmitted successfully, the list of PDU Sequence Number(s) within a PDU Set that have been lost, a PDU lost indication to indicate at least one PDU in the PDU set that has been lost, a PDU set lost indication to indicate the PDUs in the PDU set should not been transmitted and should be discarded, the mapping or relationship between PDU Sequence Number(s) within a PDU Set (e.g., in the GTP-U header from UPF) and the PDCP Sequence Number in the User plane (e.g., in GTP-U header from Node 1). Node 1 may be a RAN Node 1 and the Node 2 may be a RAN Node 2, or the Node 1 is gNB-CU and the Node 2 is gNB-DU. The information may be transmitted by control plane signaling (e.g., SN STATUS TRANSFER message in XnAP interface and/or a signaling in F1AP interface); The PDU set Sequence Number, the mapping or relationship between PDU Sequence Number(s) within a PDU Set (e.g., in the GTP-U header from UPF) and PDCP Sequence Number(s) in the User plane (e.g., in GTP-U header from Node 1) may also be transmitted by User plane (e.g., included in GTP-U header from Node 1).

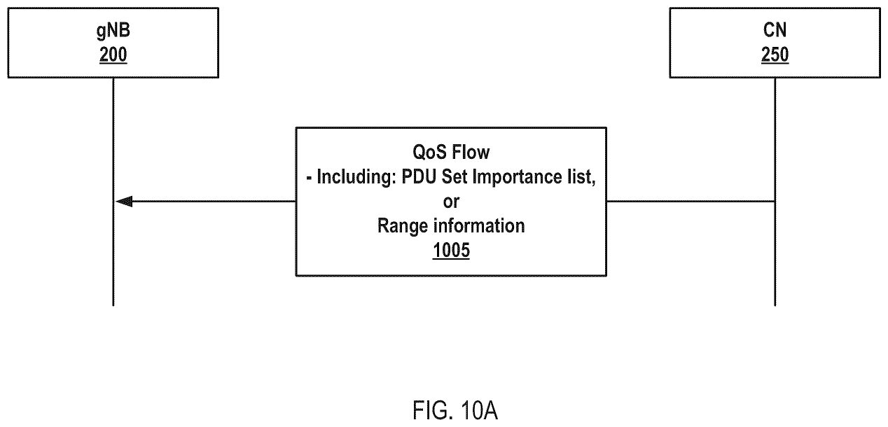

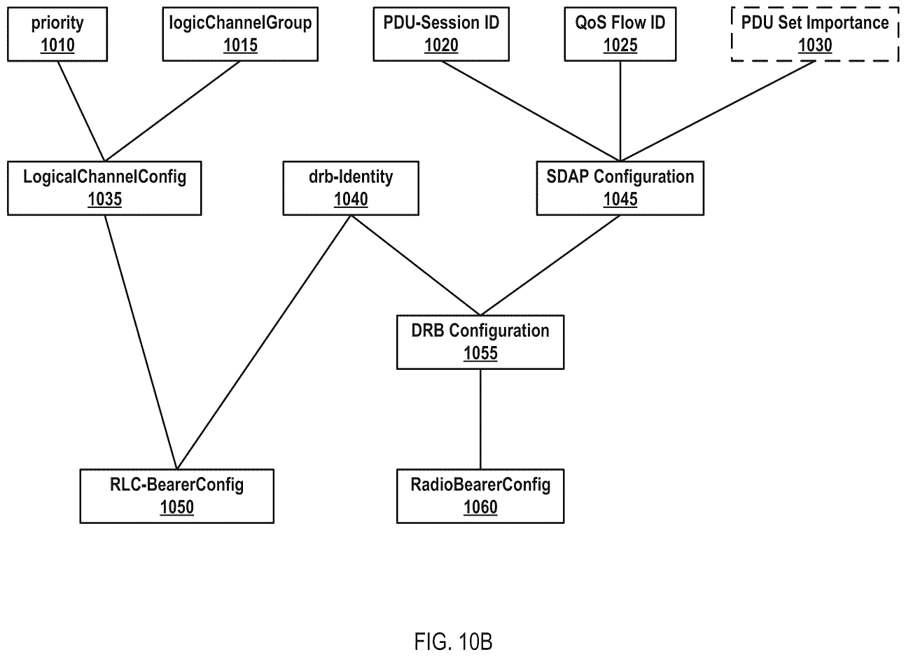

FIG. 10A shows a PDU Set Importance List or Range information 1005 sent via control plane signaling from a CN 250 to a gNB 200. The PDU Set Importance list or PDU Set Important Range information 1005 may be provided per QoS flow (e.g., included in the QoS flow item) and may indicate the PDU Set Importance that may be included in the user plane (e.g., in the GTP-U header), which may be used for mapping different PDU Set Importance(s) to different DRB(s) and/or different LCH(s). The same PDU Set Importance List or PDU Set Importance Range information 1005 may also be sent via control plane signaling from a GNB-CU to a gNB-DU or from a source gNB 200 to a target gNB 200.

FIG. 10B shows a mapping between PDU Set Importance 1030 to different DRB(s) and/or different LCH(s) 1035. The PDU Set Importance may be included in the SDAP configuration 1045, thus different PDU Set Importance(s) of the same QoS flow 1025 may be mapped to different DRBs and then to different LCHs 1035; e.g., different DRBs may be mapped to different LCHs 1035.

In another example, a PDU Set Importance 1030 may be included in the DRB configuration 1055 or RadioBearerConfig 1060, thus different PDU Set Importance(s) 1030 of the same QoS flow 1025 may be mapped to different DRBs and then to different LCHs 1035; e.g., different DRBs may be mapped to different LCHs 1035.

In another example, a PDU Set Importance 1030 may be included in the RLC-BearerConfig 1050, thus different PDU Set Importance(s) 1030 of a same DRB may be mapped to different LCHs 1035.

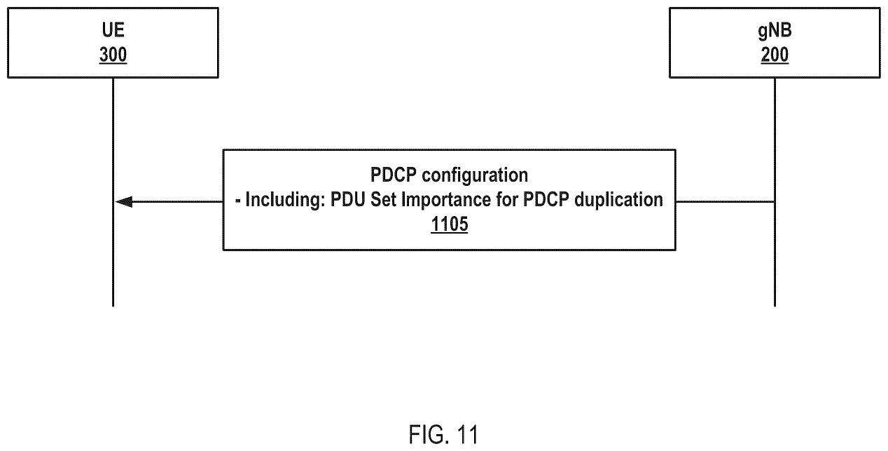

FIG. 11 shows configuration of PDCP Duplication for a PDU set with a certain PDU Set Importance 1105 when transmitted between a gNB 200 and a UE 300. The PDU Set Importance information 1105 may be configured when PDCP duplication is configured to indicate a PDU set with which PDU Set Importance should be duplicated for transmission. The PDU Set Importance information 1105 may be included in the PDCP configuration IE of an RRC message. The PDU Set Importance information 1105 may be a PDU Set Importance threshold for PDCP duplication or a PDU Set Importance range for PDCP duplication.

If the PDU Set Importance threshold for PDCP duplication is sent to a UE 300, the UE 300 may determine the PDCP duplication for the PDU set based on the PDU Set Importance threshold; e.g., the PDU set with a PDU Set Importance (PSI) equal to or higher than the PSI threshold may be duplicated for transmission over more than one RLC path.

If the PDU Set Importance range for PDCP duplication is sent to the UE 300, the UE 300 may decide the PDCP duplication for the PDU set based on the PDU Set Importance range; e.g., the PDU set with a PSI in the PSI range may be duplicated for transmission over more than one RLC path.

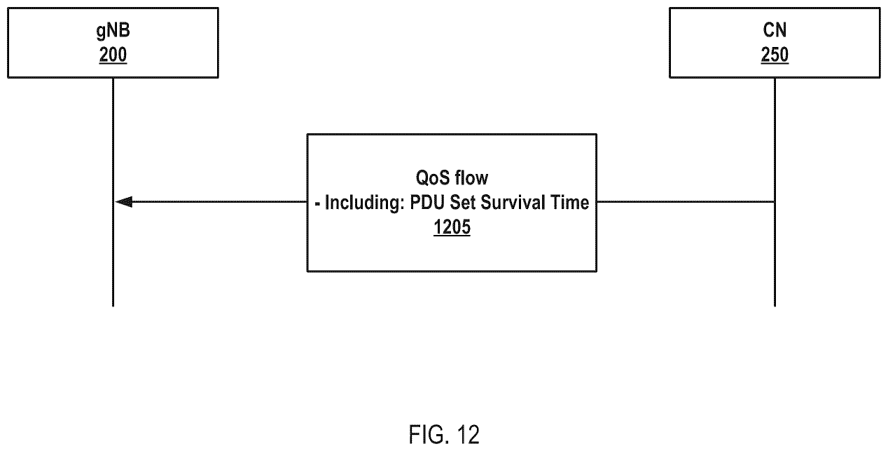

FIG. 12 shows a PDU Set Survival Time 1205 is included in the QoS flow, which is sent via the control plane from a CN 250 to a gNB 200. The PDU Set Survival time 1205 may be included in the QoS flow item or included in the TSC Assistance Information of the QoS flow and may indicate: (1) the time deadline within which the PDU set should be delivered to the receiving entity, or (2) the time period that the PDU set can survive before being received by the receiving entity; otherwise, the PDU set may be discarded. The PDU Set Survival Time 1205 may be used for the gNB 200 or UE 300 to determine the radio resource scheduling scheme; e.g., whether PDCP duplication is activated or the LCH scheduling priority.

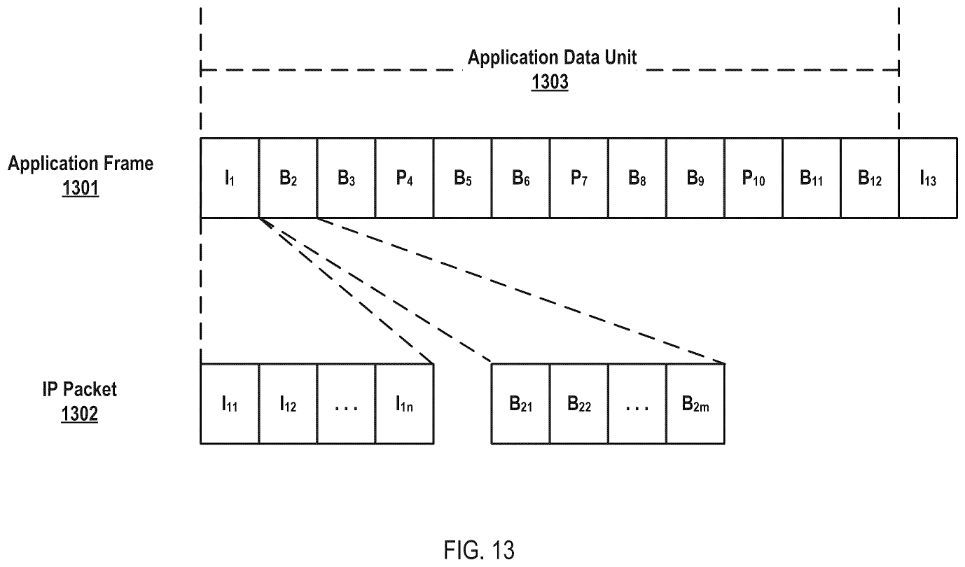

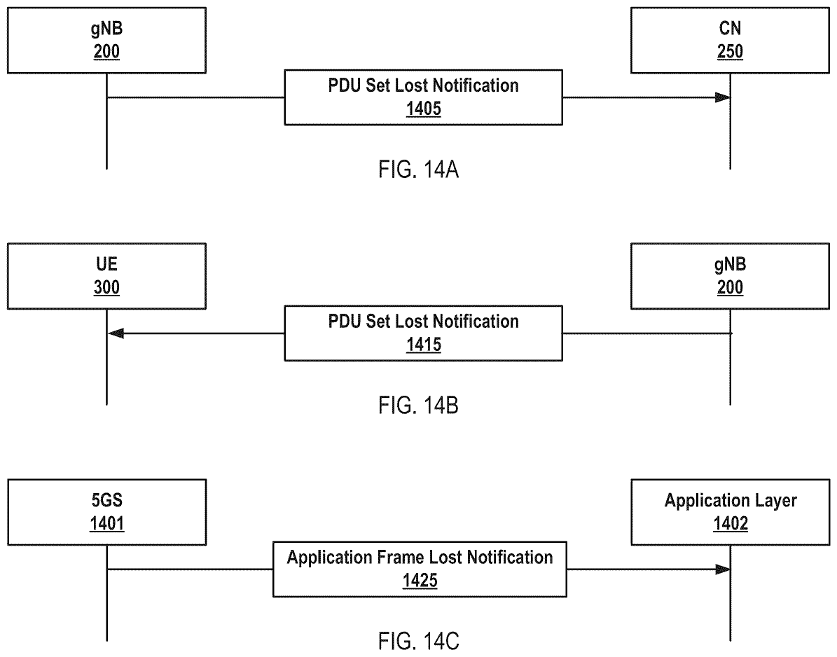

FIG. 13 shows an example application data unit structure. In XR, Metaverse, and/or Multi-modality service, one PDU set may depend on another PDU set. For instance, in FIG. 13, each Application Data Unit 1303 may be composed of multiple Application Frames 1301 (see H.264); e.g., I-frame(s), P-frame(s), and B-frame(s). The decoding of the P-frame and B-frame may depend on the successful decoding of the preceding I-frame. PDU set 2 may depend on PDU set 1. If PDU set 1 is lost, the PDU set 2 may be unnecessary. Thus, the PDU set 1 lost information should notify the CN 250 (for DL, as shown in the PDU Set Lost Notification 1405 of FIG. 14A), or notify the UE 300 (for UL, as shown in the PDU Set Lost Notification 1415 of FIG. 14B) to stop transmitting the dependent PDU Set 2, and 5GS 1401 may then notify the Application Layer 1402 of the corresponding lost application frame (as shown in the Application Frame Lost Notification 1425 of FIG. 14C) to stop transmission of the dependent Application Frame 1301. The PDU Set Lost Notification 1405 from the gNB 200 to the CN 250 may be indicated by NGAP signaling or by user plane frame (e.g., in the GTP-U header). The PDU Set Lost Notification 1415 from the gNB 200 to the UE 300 may be indicated by a PDCP header, PDCP status PDU, MAC CE, or by RRC signaling.

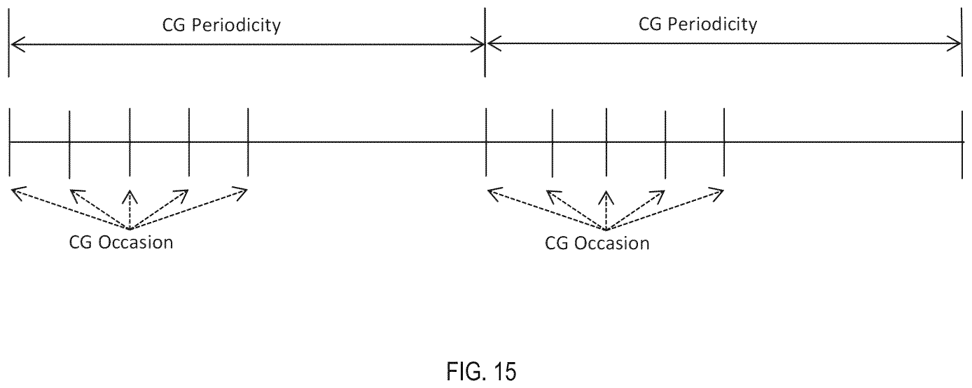

FIG. 15 shows an example that one CG period includes multiple CG occasions (e.g. multiple PUSCH transmission).

In FIG. 15, there are 5 CG resource occasions in one CG periodicity. The HARQ process ID for each CG occasion is determined by UE as following: for configured uplink grants neither configured with harq-ProcID-Offset2 nor with cg-RetransmissionTimer, the HARQ Process ID associated with the first symbol of a UL transmission of each CG occasion is derived from the following equation:

HARQ Process ID=[nrofCG-Occasions*floor(CURRENT_symbol/periodicity)+M] modulo nrofHARQ-Processes

For configured uplink grants with harq-ProcID-Offset2, the HARQ Process ID associated with the first symbol of a UL transmission is derived from the following equation:

HARQ Process ID=[nrofCG-Occasions*floor(CURRENT_symbol/periodicity)+M] modulo nrofHARQ-Processes+harq-ProcID-Offset2

where

CURRENT_symbol=(SFN×numberOfSlotsPerFrame×numberOfSymbolsPerSlot+slot number in the frame×numberOfSymbolsPerSlot+symbol number in the slot), and
numberOfSlotsPerFrame and numberOfSymbolsPerSlot refer to the number of consecutive slots per frame and the number of consecutive symbols per slot.

The SFN, the slot number in the frame, and the symbol number in the slot corresponds to the first symbol of a UL transmission in the CG periodicity (e.g., the first symbol of the first CG occasion in the CG periodicity).

nrofCG-Occasions is the number of CG occasions in one CG periodicity, configured by gNB 200 (e.g., sent from gNB 200 to UE 300).

M is the sequence number of the CG occasion in the CG periodicity, value from 0 . . . nrofCG-Occasions−1.

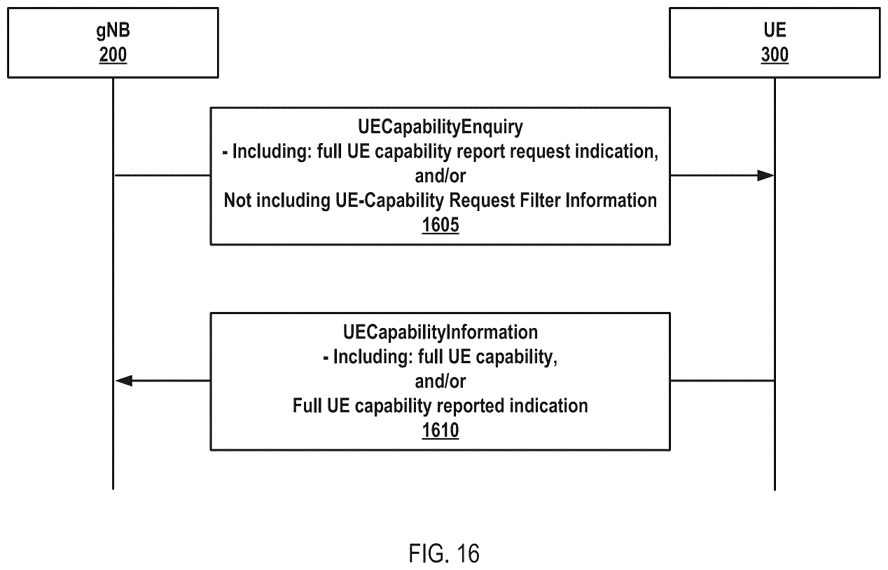

FIG. 16 shows an example for UE to avoid a UE capability filtering procedure during UE capability reporting.

In the current NR specification, to support different kinds of features for different UEs 300 (especially for a UE 300 supporting NR-DC, EN-DC with a list of frequency bands combination), the data volume of UE capability reporting may be very large. To avoid UE reporting superfluous capabilities that the network (e.g., the gNB 200) will not use (e.g., because the gNB 200 does not support the related features), the UE 300 may be required to tailor the content of the reported UE capability according to the filter signaled by the network; e.g., a list of frequency bands for which the UE 300 is requested to report the UE capability. The UE capability filtering procedure places large processing and memory demands on the UE 300. In some cases, the UE 300 may support only limited features (e.g., for eRedCap, the assumption is that the UE 300 supports only single CC operation). Therefore, the total UE capability size may be very small, and so the UE capability filtering procedure may be unnecessary.

As shown in FIG. 16, when the gNB 200 sends UECapabilityEnquiry to the UE 300, the UECapabilityEnquiry may instruct the UE 300 to report the full UE capability; e.g., the UECapabilityEnquiry may include the full UE capability report request indication, and/or not include UE-Capability Request Filter Information to instruct the UE 300 to report the full UE capability.

When the UE 300 receives the UECapabilityEnquiry, the UE 300 may decide not to perform the UE capability filtering procedure and may include the full UE capability and/or the full UE capability reported indication in UECapabilityInformation. The full UE capability reported indication may be used to indicate to the gNB 200 that all of the UE capabilities have been reported, and instructs the gNB 200 to refrain from inquiring into the UE's other capabilities. The UE 300 may decide not to perform the UE capability filtering procedure based on one or more of the following: the full UE capability report request indication included in the UECapabilityEnquiry, that the UE-Capability Request Filter Information is NOT included in the UECapabilityEnquiry, that the size of all the UE capabilities is small (e.g., not more than the maximum PDCP SDU size of 9000 Bytes), and that the UE 300 ignores the UE-Capability Request Filter Information (if included).

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

In a first aspect, a method for providing awareness of a packet data unit (PDU) set dependency in a wireless communication system comprising a first wireless device and a second wireless device includes transmitting a plurality of PDU sets from the first wireless device to the second wireless device, wherein each of the plurality of PDU sets comprises a plurality of PDUs each comprising a header and a payload; and transmitting an indication from the first wireless device to the second wireless device that describes a dependency relationship between one or more PDU sets of the plurality of PDU sets.

A second aspect includes the method of the first aspect, wherein the indication comprises a PDU set dependency indication that instructs the dependency relationship between PDU sets.

A third aspect includes the method of any preceding aspect, further comprising: losing a first PDU set, wherein the first PDU set is transmitted unsuccessfully; and based on the indication, a second PDU set depends on the first PDU set; and discarding the second PDU set.

A fourth aspect includes the method of any preceding aspect, whereinthe indication comprises a PDU set group information indicating at least one of: whether a PDU set group should be considered for PDU set delivery, a delay budget of the PDU set group, an error rate of the PDU set group, a survival time of the PDU set group, or a time period that the PDU set group can survive before being delivered to the second wireless device.

A fifth aspect includes the method of any preceding aspect claim 1, wherein the indication comprises: a PDU set group start indication that indicates the PDU set is a first PDU set of the PDU Set Group, or the indication comprises a PDU set group end indication that indicates the PDU set is a last PDU set of the PDU Set Group.

A sixth aspect includes the method of any preceding aspect, wherein the header is a user plane header, which is one of: an SDAP header, a PDCP PDU header, or an RLC PDU header.

A seventh aspect includes the method of any preceding aspect, wherein the indication comprises a PDU set dependency indication indicating at least one of: the PDU set does not depend on any other PDU set of the plurality of PDU sets; the PDU set depends on a preceding and nearest PDU set of the plurality of PDU sets; or the PDU set depends on the preceding and nearest PDU set of the plurality of PDU sets and also a subsequent PDU set.

An eighth aspect includes the method of any preceding aspect, wherein the indication comprises a PDU set sequence number and/or a QoS flow identifier that indicate the PDU set associates with another PDU set indicated by the PDU set sequence number and/or the QoS flow identifier such that the PDU set and the another PDU set should be transmitted jointly or simultaneously.

A ninth aspect includes the method of any preceding aspect, wherein the indication comprises a PDU set associated ID that indicates PDU sets having a same PDU set associated ID should be transmitted jointly or simultaneously.

A tenth aspect includes the method of any preceding aspect, wherein the indication comprises an RTT delay budget that indicates an upper bound delay from a time that the PDU set is sent to a time that a response PDU set is received.

An eleventh aspect includes the method of any preceding aspect, wherein the indication comprises an RTT delay budget that indicates a downlink PDU set has an associated uplink PDU set that will respond to the downlink PDU set.

A twelfth aspect includes the method of any preceding aspect, wherein the indication comprises a cell congestion level or a PDU set importance threshold that indicates the PDU set with PDU set importance below which is discarded, wherein the PDU set importance indicates an importance of the PDU set compared to other PDU sets of the plurality of PDU sets, and the method further comprises: discarding one or more PDU sets having the PDU set importance based on the cell congestion level or based on a threshold.

A thirteenth aspect includes the method of any preceding aspect, wherein the indication comprises a PDU set importance that indicates an importance of the PDU set compared to other PDU sets of the plurality of PDU sets, and the method further comprises: configuring a first discard timer to a longer duration for a first PDU set having a higher PDU set importance than a second discard timer for a second PDU set having a lower PDU set importance.

A fourteenth aspect includes the method of any preceding aspect, wherein the indication comprises a PDU set integrated handling information (PSIHI) that indicates whether all of the plurality of PDUs of the PDU set are needed for use by an application layer.

A fifteenth aspect includes the method of any preceding aspect, wherein the PSIHI is set to true, and the method further comprises: losing a PDU of the PDU set, then discarding remaining PDUs of the PDU set.

A sixteenth aspect includes the method of any preceding aspect, wherein the PSIHI is set to false, and the method further comprises: losing a PDU of the PDU set, and continuing to transmit the remaining PDUs of the PDU set.

A seventeenth aspect includes the method of any preceding aspect, wherein the PSIHI is set to false; the indication further comprises a PDU set integrity ratio or a PDU error rate in one PDU set; and the method further comprises: discarding transmitted and/or untransmitted PDUs in the PDU set when: the transmitted PDUs in the PDU set do not meet or exceed the PDU set integrity ratio, or lost PDUs in the PDU set exceed the PDU error rate.

An eighteenth aspect includes the method of any preceding aspect, wherein the indication comprises a PDU set importance list or PDU set important range information that indicates a PDU set importance included in the header that is used for mapping different PDU set importances to different data radio bearers (DRBs) and/or different logical channel groups (LCHs).

A nineteenth aspect includes the method of any preceding aspect, wherein the indication comprises a PDU set importance information to indicate a PDU set with which a PDU set importance should be duplicated for transmission.

A twentieth aspect includes the method of any preceding aspect, wherein the PDU set importance information is a PDU set importance threshold that specifies a PDU set importance that, when exceeded by a PDU set of the plurality of PDU sets, the PDU set is duplicated for transmission over more than one radio link protocol (RLC) path.

A twenty-first aspect includes the method of any preceding aspect, wherein the PDU set importance information is a PDU set importance range that, when the PDU set importance of a PDU set of the plurality of PDU sets falls within the PDU set importance range, the PDU set is duplicated for transmission over more than one RLC path.

A twenty-second aspect includes the method of any preceding aspect, wherein the indication comprises a PDU set survival time that indicates at least one of: a time deadline within which the PDU set should be delivered, or a time period that the PDU set can survive before being received and otherwise discarded.

A twenty-third aspect includes a a device for wireless communication comprising: a processor; and a memory in communication with the processor, the memory storing a plurality of instructions executable by the processor to cause the device to: implement the method of any preceding aspect.

A twenty-fourth aspect includes a non-transitory computer-readable medium comprising instructions operable, when executed by one or more processors, to: implement the method of any preceding aspect.

A twenty-fifth aspect includes a method of determining a Hybrid ARQ (Automatic Repeat reQuest) (HARQ) process ID for each configured grant (CG) occasion of a CG periodicity, comprising: determining, by a user equipment (UE), the HARQ process ID for configured uplink (UL) grants neither configured with harq-ProcID-Offset2 nor cg-RetransmissionTimer according to the following equation: HARQ Process ID=[nrofCG-Occasions×floor(CURRENT_symbol/periodicity)+M] modulo nrofHARQ-Processes; and determining, by the UE, the HARQ process ID for a first symbol of a UL transmission according to the following equation: HARQ Process ID=[nrofCG-Occasions×floor(CURRENT_symbol/periodicity)+M] modulo nrofHARQ-Processes+harq-ProcID-Offset2, wherein nrofCG-Occasions is a number of CG occasions in one CG periodicity, M is a sequence number of the CG occasion in the CG periodicity, CURRENT_symbol=(system frame number (SFN)×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot.

A twenty-sixth aspect includes a method for a user equipment (UE) to avoid a UE capability filtering procedure during capability reporting in a wireless communication system comprising the UE and a base station, the method comprising: receiving, by the UE, a UECapabilityEnquiry from the base station, wherein the UECapabilityEnquiry comprises a full UE capability report request indication with or without a UE-capability request filter information; determining, by the UE, not to perform the UE capability filtering procedure; and sending a UECapabilityInformation comprising a full UE capability and/or a full UE capability reported indication to the base station.

A twenty-seventh aspect includes the method of aspect 26, wherein the full UE capability reported indication indicates to the base station that all UE capabilities have been reported and instructs the base station to refrain from inquiring into other capabilities of the UE.

A twenty-eighth aspect includes the method of aspects 26 or 27, wherein the determining not to perform the UE capability filtering procedure is based one or more of: the full UE capability report request indication; that the UE-capability request filter information is not included in the UECapabilityEnquiry; that a size of all UE capabilities is not more than a maximum PDCP SDU size; and/or that the UE ignores the UE-capability request filter information when the UE-capability request filter information is included.

1. A method for providing awareness of a packet data unit (PDU) set dependency in a wireless communication system comprising a first wireless device and a second wireless device, the method comprising:
transmitting a plurality of PDU sets from the first wireless device to the second wireless device, wherein
each of the plurality of PDU sets comprises a plurality of PDUs each comprising a header and a payload; and
transmitting an indication from the first wireless device to the second wireless device that describes a dependency relationship between one or more PDU sets of the plurality of PDU sets.

2. The method of claim 1, wherein
the indication comprises a PDU set dependency indication that instructs the dependency relationship between PDU sets.

3. The method of claim 2, further comprising:
losing a first PDU set, wherein
the first PDU set is transmitted unsuccessfully; and
based on the indication, a second PDU set depends on the first PDU set; and
discarding the second PDU set.

4. The method of claim 1, wherein the indication comprises at least one of:
a PDU set group information indicating at least one of:
whether a PDU set group should be considered for PDU set delivery,
a delay budget of the PDU set group,
an error rate of the PDU set group,
a survival time of the PDU set group, or
a time period that the PDU set group can survive before being delivered to the second wireless device;
a PDU set group start indication that indicates the PDU set is a first PDU set of the PDU SET Group, or
a PDU set group end indication that indicates the PDU set is a last PDU set of the PDU Set Group.

5. The method of claim 1, wherein
the header is a user plane header, which is one of:
an SDAP header,
a PDCP PDU header, or
an RLC PDU header.

6. The method of claim 1, wherein the indication comprises at least one of:
a PDU set dependency indication indicating at least one of:
the PDU set does not depend on any other PDU set of the plurality of PDU sets;
the PDU set depends on a preceding and nearest PDU set of the plurality of PDU sets; or
the PDU set depends on the preceding and nearest PDU set of the plurality of PDU sets and also a subsequent PDU set;
a PDU set sequence number and/or a QoS flow identifier that indicate the PDU set associates with another PDU set indicated by the PDU set sequence number and/or the QoS flow identifier such that the PDU set and the another PDU set should be transmitted jointly or simultaneously; or
a PDU set associated ID that indicates PDU sets having a same PDU set associated ID should be transmitted jointly or simultaneously.

7. The method of claim 1, wherein the indication comprises an RTT delay budget that indicates at least one of:
an upper bound delay from a time that the PDU set is sent to a time that a response PDU set is received; or
a downlink PDU set has an associated uplink PDU set that will respond to the downlink PDU set.

8. The method of claim 1, wherein
the indication comprises a cell congestion level or a PDU set importance threshold that indicates the PDU set with PDU set importance below which is discarded, wherein
the PDU set importance indicates an importance of the PDU set compared to other PDU sets of the plurality of PDU sets, and
the method further comprises:
discarding one or more PDU sets having the PDU set importance based on the cell congestion level or based on a threshold.

9. The method of claim 1, wherein
the indication comprises a PDU set importance that indicates an importance of the PDU set compared to other PDU sets of the plurality of PDU sets, and
the method further comprises:
configuring a first discard timer to a longer duration for a first PDU set having a higher PDU set importance than a second discard timer for a second PDU set having a lower PDU set importance.

10. The method of claim 1, wherein
the indication comprises a PDU set integrated handling information (PSIHI) that indicates whether all of the plurality of PDUs of the PDU set are needed for use by an application layer.

11. The method of claim 10, wherein
the PSIHI is set to true, and the method further comprises:
losing a PDU of the PDU set, then
discarding remaining PDUs of the PDU set;
the PSIHI is set to false, and the method further comprises:
losing a PDU of the PDU set; and
continuing to transmit the remaining PDUs of the PDU set; or
the PSIHI is set to false, the indication further comprises a PDU set integrity ratio or a PDU error rate in one PDU set, and the method further comprises:
discarding transmitted and/or untransmitted PDUs in the PDU set when:
the transmitted PDUs in the PDU set do not meet or exceed the PDU set integrity ratio, or
lost PDUs in the PDU set exceed the PDU error rate.

12. The method of claim 1, wherein
the indication comprises a PDU set importance list or PDU set important range information that indicates a PDU set importance included in the header that is used for mapping different PDU set importances to different data radio bearers (DRBs) and/or different logical channel groups (LCHs).

13. The method of claim 1, wherein
the indication comprises a PDU set importance information to indicate a PDU set with which a PDU set importance should be duplicated for transmission.

14. The method of claim 13, wherein
the PDU set importance information is a PDU set importance threshold that specifies a PDU set importance that, when exceeded by a PDU set of the plurality of PDU sets, the PDU set is duplicated for transmission over more than one radio link protocol (RLC) path; or
the PDU set importance information is a PDU set importance range that, when the PDU set importance of a PDU set of the plurality of PDU sets falls within the PDU set importance range, the PDU set is duplicated for transmission over more than one RLC path.

15. The method of claim 1, wherein
the indication comprises a PDU set survival time that indicates at least one of:
a time deadline within which the PDU set should be delivered, or
a time period that the PDU set can survive before being received and otherwise discarded.

16. A device for wireless communication comprising:
a processor; and
a memory in communication with the processor, the memory storing a plurality of instructions executable by the processor to cause the device to:
implement the method of claim 1.

17. A method of determining a Hybrid ARQ (Automatic Repeat reQuest) (HARQ) process ID for each configured grant (CG) occasion of a CG periodicity, comprising:
determining, by a user equipment (UE), the HARQ process ID for configured uplink (UL) grants neither configured with harq-ProcID-Offset2 nor cg-RetransmissionTimer according to the following equation:
HARQ Process ID=[nrofCG-Occasions×floor(CURRENT_symbol/periodicity)+M] modulo nrofHARQ-Processes; and
determining, by the UE, the HARQ process ID for a first symbol of a UL transmission according to the following equation:
HARQ Process ID=[nrofCG-Occasions×floor(CURRENT_symbol/periodicity)+M] modulo nrofHARQ-Processes+harq-ProcID-Offset2, wherein
nrofCG-Occasions is a number of CG occasions in one CG periodicity,
M is a sequence number of the CG occasion in the CG periodicity,
CURRENT_symbol=(system frame number (SFN)×numberOfSlotsPerFrame×numberOfSymbolsPerSlot+slot number in the frame×numberOfSymbolsPerSlot+symbol number in the slot), and
numberOfSlotsPerFrame and numberOfSymbolsPerSlot refer to the number of consecutive slots per frame and the number of consecutive symbols per slot.

18. A method for a user equipment (UE) to avoid a UE capability filtering procedure during capability reporting in a wireless communication system comprising the UE and a base station, the method comprising:
receiving, by the UE, a UECapabilityEnquiry from the base station, wherein
the UECapabilityEnquiry comprises a full UE capability report request indication with or without a UE-capability request filter information;
determining, by the UE, not to perform the UE capability filtering procedure; and
sending a UECapabilityInformation comprising a full UE capability and/or a full UE capability reported indication to the base station.

19. The method of claim 18, wherein
the full UE capability reported indication indicates to the base station that all UE capabilities have been reported and instructs the base station to refrain from inquiring into other capabilities of the UE.

20. The method of claim 18, wherein
the determining not to perform the UE capability filtering procedure is based one or more of:
the full UE capability report request indication;
that the UE-capability request filter information is not included in the UECapabilityEnquiry;
that a size of all UE capabilities is not more than a maximum PDCP SDU size; and/or
that the UE ignores the UE-capability request filter information when the UE-capability request filter information is included.
